(19) United States
(12) Patent Application Publication
(10) Pub. No.: US 2012/0282452 A1
(43) Pub. Date: Nov. 8, 2012

(54) Multi-Layered Decorative Object and Methods

(76) Inventor: Constance Kolman, Sudbury, MA (US)

(21) Appl. No.: 13/465,380

(22) Filed: May 7, 2012

Related U.S. Application Data
(60) Provisional application No. 61/482,694, filed on May 5, 2011.

(51) Int. Cl. B32B 29/00; B32B 27/10; B05D 1/36; B32B 15/00; B32B 29/06; B32B 37/12; B32B 17/06; B32B 3/18

(52) U.S. Cl. 428/221; 428/537.5; 428/410; 428/511; 428/457; 428/438; 156/305; 427/203

(57) ABSTRACT

The present invention relates to methods for creating a multi-layered decorative object on a transparent surface and the resulting object. The process includes providing a substantially rigid transparent layer including a transparent material, applying a paper material having a rear painted surface to a rear surface of the transparent material to form a paper layer, and sealing materials on the transparent layer with a sealant to form a rear sealing layer. The resulting design may be seen through the transparent layer.

### CROSS-REFERENCE TO RELATED APPLICATION

This application claims priority to, and the benefit of, U.S. provisional patent application Ser. No. 61/482,694, filed on May 5, 2011, entitled “Glass Titles and Methods of Manufacturing Same.”

### FIELD OF THE INVENTION

The present invention relates generally to multi-layered decorative objects, and more specifically to multiple layers behind a transparent ceramic front.

### BACKGROUND OF THE INVENTION

Various methods for decorating objects are known, such as decoupage, which involves applying paper to a top surface of an object (e.g., furniture) and then sealing the paper with varnishes to integrate the paper with the object. This can require several layers of varnish, commonly up to 30-40 layers, which is then sanded. Typically the paper includes a specific image to be retained as accurately as possible.

Accordingly, there is a need for a versatile technique to create a decorative object while retaining the original upper surface. There is also a need for such a technique to be adaptable for creating abstract images and various treatments.

### SUMMARY OF THE INVENTION

The present invention relates to methods for creating a multi-layered decorative object on a transparent surface and the resulting object. By using a transparent surface, several layers may be applied to the rear of the transparent surface and seen from the front. Rear application of the layers may better protect the decorative layers with fewer protective layers.

According to one aspect, the invention relates to a multi-layered decorative object. The object has a transparent layer made of a transparent material, a paper layer with a rear painted surface located on a rear surface of the transparent layer, and a rear sealant layer opposite the transparent layer.

In accordance with one embodiment of the above aspect, the transparent material may be selected from materials such as tempered glass, annealed glass, and/or plexiglass. As an example, the paper layer may be momi paper, and may made of multiple different paper pieces. In some embodiments, the paper layer may be made of glue-soaked paper. The object may include a leaf adhesive layer adjacent to the paper layer and a metallic leaf layer on the leaf adhesive layer. A metallic leaf sealant layer may be located on the metallic leaf layer and a paint layer may be disposed on the metallic leaf sealant layer. In some embodiments, the object includes a backing layer next to the rear sealant layer. The backing layer may be made of a paper or a fabric backing layer material. In other embodiments, the object includes a second paper layer next to the rear sealant layer.

In accordance with another aspect, the invention relates to a process for forming a multi-layered decorative object. The process includes providing a substantially rigid transparent layer including a transparent material, applying a paper material having a rear painted surface to a rear surface of the transparent material to form a paper layer, and sealing materials on the transparent layer with a sealant to form a rear sealing layer.

In accordance with one embodiment of the above-identified aspect, the transparent material may be tempered glass, annealed glass, or plexiglass, and in some instances the paper material may be momi paper. In some embodiments, the paper layer application step includes applying the paper material in a plurality of pieces. The paper material may be a glue-soaked paper. In other embodiments, the process includes, after applying the paper, applying a leaf adhesive layer including a leaf adhesive, and applying a metallic leaf layer including a metallic leaf material. This process may also include applying a metallic leaf sealant layer on the metallic leaf layer and painting the metallic leaf sealant layer to form a paint layer. Before the rear sealing step, a backing layer including a backing layer material may be installed on the layers on the transparent layer. The backing material may be paper or fabric. In certain embodiments, a second paper layer may be applied prior to the rear sealing step.

### BRIEF DESCRIPTION OF THE FIGURES

Other features and advantages of the present invention, as well as the invention itself, can be more fully understood from the following description of the various embodiments, when read together with the accompanying drawings, in which:

FIG. 1 is a schematic, perspective, exploded partial view of the component layers of an object, in accordance with one embodiment of the invention; and

FIG. 2 is a flow chart depicting a method for creating a multi-layered object as illustrated in FIG. 1, in accordance with another embodiment of the invention.

### DETAILED DESCRIPTION OF THE INVENTION

The invention may be better understood by reference to the following detailed description, taken in conjunction with the figures. Various embodiments of the invention relate to a multi-layered decorative object for use in a variety of applications, including as bowls, vases, glass tables, door inserts, partitions, elevator linings, wall panels, sectioning walls, stairs, countertops, cabinet glass, backsplashes, reception desk surrounds, headboards, and framed artwork, amongst many others. The resulting designs from the multiple layers may be abstract, having no defined lines or subject matter, or may be designed to represent a structure or figure. The variety of materials used further adds to the design and durability of the resulting object. Other configurations and variants will be apparent to those skilled in the art from the teachings herein.

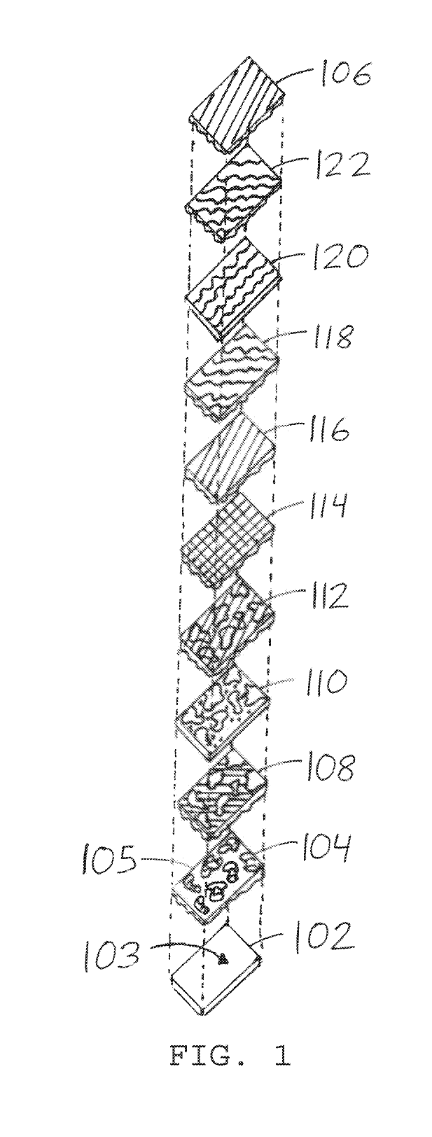

FIG. 1 depicts several different layers that may make up a multi-layered object 100. The multi-layered object 100 begins with a transparent layer 102. This transparent layer 102 may be made of any of a variety of materials, including tempered glass, annealed glass, and plexiglass, and may be substantially rigid. The transparent layer 102 may take many forms, bound primarily by the limitations of the chosen material. For example, the transparent layer 102 may be a panel, a bowl, a vase, a tile, or other form. When using tempered glass, pieces of many sizes may be made, for example tiles of approximately 12″×12″ and greater, with thicknesses of approximately ¼″ to ½″. At times, it may be desirable to use tempered glass with iron removed. A variety of tile sizes may also be made from annealed glass, including up to approximately 12″×12″. While certain exemplary dimensions and forms have been presented, these dimensions and forms are not intended to be limiting, and a variety of dimensions and forms for every type of material are contemplated. Larger pieces may be formed from a combination of smaller pieces, either of the same material or different materials.

A paper layer 104 made of a paper material may be applied to a rear surface 103 of the transparent layer. Several types of paper may be used, including That and/or Momi papers, which may behave like a “fabric.” These papers may be marbled. The paper layer 104 may have a rear painted surface 105, altering the appearance of a front surface of the paper when viewed through the transparent layer 102. The rear painted surface 105 may be painted before or after application of the paper to the transparent layer 102. Other treatments include dyeing the paper or soaking the paper in glue. When soaked in glue, the glue solution may be conventional craft glue, and in other cases the glue may be diluted with water or some other thinner. One particular implementation uses standard craft glue and water with a ratio of 3:1 or 4:1.

The paper layer 104 may be made of a single piece of paper applied to the transparent layer 102, but is often made of several different pieces of paper. Some portions of the transparent layer 102 may be left uncovered. These uncovered areas may be left alone or treated as described below, including being painted or otherwise decorated. The paper layer 104 may be applied to the rear surface 103 of the transparent layer 102 using one's fingers or a brayer to remove air bubbles and otherwise smooth out the application. In some cases, excess glue may be removed using, for example, a damp sponge. The process of soaking, applying and smoothing the paper is repeated until a desired design is complete. The application paper is then allowed to dry. Once the glue is dry, a damp sponge is again used to remove any excess glue that may have dried onto the transparent layer 102 not covered by the paper layer 104. Some or all of these steps may be automated and/or done using a combination of human activity and machinery.

If there are no other layers to apply, the paper layer 104 may be sealed by a sealant forming a rear sealant layer 106. If additional layers are to be added, the rear sealant layer 106 is added last such that it is opposite the transparent layer 102. Exemplary additional layers include a leaf adhesive layer 108 and a metallic leaf layer 110. Before applying additional layers such as the leaf adhesive layer 108, any moisture that may have leaked onto the paper layer 104 is allowed to dry. The leaf adhesive layer 108 includes a leaf adhesive that forms a bond for the metallic leaf between the paper layer 104 and the metallic leaf layer 110. Using a paintbrush or other similar applicator, metallic leaf adhesive (also known as metallic leaf sizing) may be brushed onto areas that are to be covered with metallic leaf. The metallic leaf adhesive layer 108 is then allowed to dry prior to adding the metallic leaf layer 110 as the metallic leaf adhesive layer 108 may be clear and tacky to the touch.

The metallic leaf layer 110 may then be applied to the areas covered by the metallic leaf adhesive layer 108 using sheets of metallic leaf. Once the leaf has been applied, wax paper may be pressed onto the layers on the transparent layer 102 by rubbing the entire sheet of wax paper over the layers, including the metallic leaf layer 110 and the paper layer 104. For best results, the transparent layer 102 may be placed face down for approximately 2-3 hours, allowing the reverse side with the paper layer 104, the metallic adhesive layer 108, and the metallic leaf layer 110 to dry. In some embodiments, the drying time may be approximately 1 hour.

Once the metallic leaf layer 110 has been adhered, and the metallic leaf adhesive layer 108 is dry, any excess metallic foil may be removed using a stiff, wide-edge paint brush or other similar tool. Additional applications of adhesive and foil may be applied at the discretion of the artisan using the steps described above. Once all the metallic foils and adhesives have been applied and dried, a metallic leaf sealant layer 112 including a leaf sealant (e.g., Mod Podge® by Plaid Enterprises (Norcross, Ga.) or Liquitex varnish (Piscataway, N.J.)) may be applied to the exposed backside of the layers on the transparent layer 102. Once dry (usually about 1-2 hours), another coat of foil sealant may be applied and left to dry for about 24-48 hours. Depending on the application, different periods of time may be suitable. For a more saturated look, the foil sealant may be applied only to areas with the metallic leaf.

If desired, a paint layer 114 may be applied. If the paint is applied after the metallic leaf sealant layer 112, the paint may be applied directly on the dried metallic leaf sealant layer 112. In many applications latex paint is used, and the color may be selected by the artisan based on a desired amount of light to be shown through the transparent layer 102, which in turn impacts the color of the paper layer 104. Often, a minimum of two coats of paint is applied and dried—the amount of time varies according to the viscosity of the paint used. Sometimes this takes between 3 and 6 hours before another coat can be applied, and other times may take between 2 and 3 hours. Once the desired coats of paint are thoroughly dried (which takes approximately 12 hours in some cases), another sealant layer 116 may be applied to the layers on the transparent layer 102. A razor blade or knife may be used to remove any excess glue, sealant, and/or paper from the edge or front of the transparent layer 102 at this stage, or at any other stage if desired.

Continuing with the application, and once the applied layers are completely dry, a glue layer 118 of glue solution may be applied over the sealant layer 116. The glue layer 118 may provide an adhesive for attaching a backing layer 120. The backing layer 120 may provide additional protection to the assembled layers, and may be made of many materials, including a piece of fabric or paper. The backing layer 120 may be cut approximately ¼″ to ½″ larger than the transparent layer 102 and then applied to the glue layer 118. A layer of glue solution is then added over the backing layer 120 to form a second glue layer 122, and a brayer may be used to remove excess glue. This coat may be allowed to dry thoroughly, which may take approximately 24 hours. As described previously, once all layers have been applied and are dry, the rear sealant layer 106 is applied. Depending upon the use of the object 100, an additional layer of epoxy may be applied to the back of the assembled layers and sides. For example, when the object 100 is being designed for use as a coffee table, the additional protection may be warranted, as the epoxy provides a protective barrier in the event the end-user spills liquid on the table and the liquid seeps under the transparent layer 102. If the object 100 is being created for purely artistic purposes, e.g., as a framed piece of art, the additional epoxy may not be necessary.

In an alternative embodiment, particularly where both sides of the object 102 may be visible, the artisan may want to present a design on both sides. To do this, the artisan may repeat the process substantially in reverse, e.g., by applying a second paint layer 114 on the sealant layer 118, followed by a second sealant layer 112, metallic leaf adhesive layer 108, metallic leaf layer 110, and paper layer 104, before applying the rear sealant layer 106. These second layers may be substantially similar to their counterparts, or may be different to create a different design.

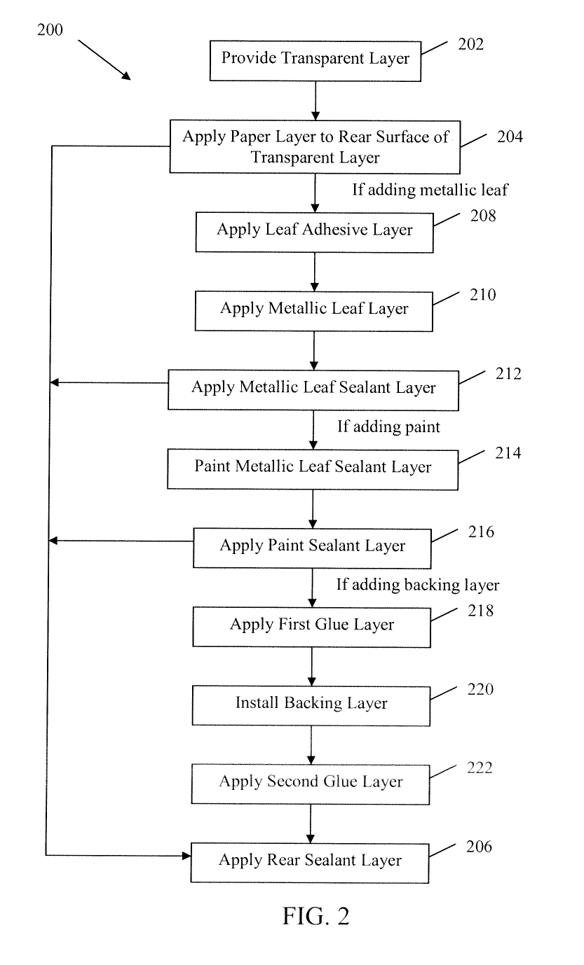

FIG. 2 depicts one exemplary process 200, though as described above, several variations are contemplated, including in the ordering of the steps. The process 200 begins with providing a substantially rigid transparent layer that is made of a transparent material (step 202). Next, a paper layer is applied to a rear surface of the transparent layer (step 204). If no other layers are to be added, the rear sealant layer may be applied (step 206). If metallic leaf will be added, then a leaf adhesive layer is applied to the paper and/or transparent material (step 208) and the metallic leaf layer is applied to the leaf adhesive layer (step 210) before applying a metallic leaf sealant layer (step 212). If adding paint, then the metallic leaf sealant layer (and optionally any exposed transparent material) are painted (step 214) and then sealed by applying a paint sealant layer (step 216). Otherwise, the rear sealant layer may be applied (step 206). For instances where a backing layer is desired, a first glue layer is applied (step 218), followed by installing the backing layer (step 220), and applying a second glue layer (step 222), before applying the rear sealant layer (step 206).

Various embodiments and features of the present invention have been described in detail with particularity. The utilities thereof can be appreciated by those skilled in the art. It should be emphasized that the above-described embodiments of the present invention merely describe certain examples implementing the invention, including the best mode, in order to set forth a clear understanding of the principles of the invention. Numerous changes, variations, and modifications can be made to the embodiments described herein and the underlying concepts, without departing from the spirit and scope of the principles of the invention. All such variations and modifications are intended to be included within the scope of the present invention, as set forth herein. The scope of the present invention is to be defined by the claims, rather than limited by the forgoing description of various preferred and alternative embodiments. Accordingly, what is desired to be secured by Letters Patent is the invention as defined and differentiated in the claims, and all equivalents.

What is claimed is:

1. A multi-layered decorative object comprising:
a transparent layer comprising a transparent material;
a paper layer disposed on a rear surface of the transparent layer, wherein the paper layer comprises a rear painted surface; and
a rear sealant layer opposite the transparent layer.

2. The object of claim 1, wherein the transparent material is selected from the group consisting of tempered glass, annealed glass, and plexiglass.

3. The object of claim 1, wherein the paper layer comprises momi paper.

4. The object of claim 1, wherein the paper layer comprises a plurality of paper pieces.

5. The object of claim 1, wherein the paper layer comprises a glue soaked paper.

6. The object of claim 1 further comprising:
a leaf adhesive layer adjacent the paper layer; and
a metallic leaf layer disposed on the leaf adhesive layer.

7. The object of claim 6 further comprising:
a metallic leaf sealant layer disposed on the metallic leaf layer; and
a paint layer disposed on the metallic leaf sealant layer.

8. The object of claim 1 further comprising a backing layer disposed proximate the rear sealant layer.

9. The object of claim 8, wherein the backing layer comprises a backing layer material selected from the group consisting of paper and fabric.

10. The object of claim 1 further comprising a second paper layer, wherein the second paper layer is disposed adjacent the rear sealant layer.

11. A process for forming a multi-layered decorative object, the process comprising the steps of:
providing a substantially rigid transparent layer comprising a transparent material;
applying a paper material comprising a rear painted surface to a rear surface of the transparent material to form a paper layer; and
sealing materials disposed on the transparent layer with a sealant to form a rear sealing layer.

12. The process of claim 11, wherein the transparent material is selected from the group consisting of tempered glass, annealed glass, and plexiglass.

13. The process of claim 11, wherein the paper material comprises momi paper.

14. The process of claim 11, wherein the paper layer application step further comprises applying the paper material in a plurality of pieces.

15. The process of claim 11, wherein the paper material comprises a glue soaked paper.

16. The process of claim 11 further comprising the steps of:
following the paper layer application step, applying a leaf adhesive layer comprising a leaf adhesive; and
applying a metallic leaf layer comprising a metallic leaf material.

17. The process of claim 16 further comprising the steps of:
applying a metallic leaf sealant layer on the metallic leaf layer; and
painting the metallic leaf sealant layer to form a paint layer.

18. The process of claim 11 further comprising the step of, before the rear sealing step, installing a backing layer comprising a backing layer material on the layers disposed on the transparent layer.

19. The process of claim 18, wherein the backing material is selected from the group consisting of paper and fabric.

20. The process of claim 11 further comprising the step of, before the rear sealing step, applying a second paper layer.
